(19) United States
(12) Patent Application Publication
(10) Pub. No.: US 2025/0266650 A1
(43) Pub. Date: Aug. 21, 2025

(54) CONNECTOR MATING SENSOR ASSEMBLY FOR POWER CONNECTOR SYSTEM

(71) Applicant: TE Connectivity Solutions GmbH, Schaffhausen (CH)

(72) Inventors: Matthew Edward Mostoller, Hummelstown, PA (US); Christopher George Daily, Harrisburg, PA (US)

(21) Appl. No.: 18/443,932

(22) Filed: Feb. 16, 2024

(51) Int. Cl. H01R 13/66; H01R 12/71; H01R 13/05; H01R 13/502; H01R 13/52; H02J 7/00

(52) U.S. Cl. CPC H01R 13/6683; H01R 12/716; H01R 13/052; H01R 13/502; H01R 13/5213; H02J 7/0042

(57) ABSTRACT

A receive charging device includes a receive power connector having a receive housing with a mating end at a front having a receptacle configured to receive a supply power connector. The receive charging device includes receive power contacts for mating with supply power contacts of the supply power connector. The receive charging device includes a connector mating sensor assembly configured to be operably coupled to the supply power connector to indicate a mating status of the receive power connector with the supply power connector. The mating status is one of connected or disconnected.

### BACKGROUND OF THE INVENTION

The subject matter herein relates generally to power connectors.

Mobile devices, such as electric vehicles, mobile robots, or other types of rechargeable mobile vehicles are movable within an environment to perform a task. The mobile devices need to be recharged from time to time. The mobile devices are returned to a charging station to supply power to the mobile device and recharge the batteries of the mobile device. A charging connector may be plugged onto a power connector of the mobile device to recharge the batteries of the mobile device. The charging connectors are susceptible to damage if the mobile device moves prior to full disconnection of the charging connectors. Some power connectors include a first mate, last break sensor for the contacts of the connectors to indicate to the system that the contacts are disconnected. However, such systems do not indicate when the housings or other components are fully disconnected.

A need remains for a charging connector system for mobile devices that indicates full disconnection of the charging connectors.

### BRIEF DESCRIPTION OF THE INVENTION

In one embodiment, a receive charging device for a mobile device is provided. The receive charging device includes a receive power connector that has a receive housing extending between a front and a rear. The receive power connector has a mating end at the front. The receive housing includes a receptacle at the mating end configured to receive a supply power connector along a mating axis. The receive power connector has a cable end at the rear. The receive charging device includes a contact assembly held by the receive housing. The contact assembly includes receive power contacts for mating with supply power contacts of the supply power connector. The receive charging device includes a cable assembly coupled to the contact assembly. The cable assembly includes power cables terminated to the corresponding receive power contacts. The power cables extend from the cable end. The receive charging device includes a connector mating sensor assembly configured to be operably coupled to the supply power connector to indicate a mating status of the receive power connector with the supply power connector. The mating status is one of connected or disconnected.

In another embodiment, a receive charging device for a mobile device is provided. The receive charging device includes a receive power connector that has a receive housing extending between a front and a rear. The receive power connector has a mating end at the front. The receive housing includes a receptacle at the mating end configured to receive a supply power connector along a mating axis. The receive power connector has a cable end at the rear. The receive charging device includes a contact assembly held by the receive housing. The contact assembly includes receive power contacts for mating with supply power contacts of the supply power connector. The receive charging device includes a cable assembly coupled to the contact assembly. The cable assembly includes power cables terminated to the corresponding receive power contacts. The power cables extend from the cable end. The receive charging device includes a connector mating sensor assembly configured to be operably coupled to the supply power connector to indicate a mating status of the receive power connector with the supply power connector. The mating status is one of connected or disconnected. The connector mating sensor assembly includes a connector mating sensor has a switch element. The connector mating sensor assembly includes an actuator operably coupled to the switch element. The actuator has an engagement tip located in the receptacle to interface with the supply power connector when the supply power connector is in the receptacle to activate the switch element indicating the connected mating status. The actuator is released when the supply power connector is removed from the receptacle to deactivate the switch element indicating the disconnected mating status.

In a further embodiment, a charging system is provided and includes a supply charging device that includes a supply power connector that has a supply housing extending between a front and a rear. The supply housing has a top and a bottom. The supply power connector has a mating end at the front. The supply power connector has a cable end opposite the mating end. The supply power connector includes supply power contacts held by the supply housing. The supply charging device includes a supply cable assembly coupled to the supply power connector and extends from the cable end. The supply cable assembly includes supply power cables terminated to the corresponding supply power contacts. The charging system includes a receive charging device for a mobile device. The receive charging device includes a receive power connector has a receive housing extends between a front and a rear. The receive power connector has a mating end at the front configured to be mated with the mating end of the supply power connector. The receive housing includes a receptacle at the mating end configured to receive a supply power connector along a mating axis. The receive power connector has a cable end at the rear. The receive charging device includes a receive contact assembly held by the receive housing includes receive power contacts for mating with the supply power contacts of the supply power connector. The receive charging device includes a receive cable assembly coupled to the receive contact assembly and extends from the cable end. The receive cable assembly includes receive power cables terminated to the corresponding receive power contacts. The receive charging device includes a connector mating sensor assembly configured to be operably coupled to the supply power connector to indicate a mating status of the receive power connector with the supply power connector. The mating status is one of connected or disconnected.

### BRIEF DESCRIPTION OF THE DRAWINGS

FIG. 1 illustrates a charging system for charging a mobile device in accordance with an exemplary embodiment.

FIG. 2 illustrates a charging system for charging a mobile device in accordance with an exemplary embodiment.

FIG. 3 illustrates a front view of the receive charging device in accordance with an exemplary embodiment.

FIG. 4 illustrates a front view of the supply charging device in accordance with an exemplary embodiment.

FIG. 5 is a front perspective view illustrating the receive charging device in accordance with an exemplary embodiment.

FIG. 6 is a cross sectional view of a portion of the receive charging device in accordance with an exemplary embodiment.

FIG. 7 is a cross sectional view of a portion of the charging system showing the supply charging device partially mated to or partially unmated from the receive charging device in accordance with an exemplary embodiment.

FIG. 8 is a front perspective view illustrating the receive charging device in accordance with an exemplary embodiment.

FIG. 9 is a cross sectional view of a portion of the receive charging device in accordance with an exemplary embodiment.

FIG. 10 is a front perspective view of the receive charging device in accordance with an exemplary embodiment.

FIG. 11 is a cross sectional view of a portion of the charging system showing the supply charging device fully mated to the receive charging device in accordance with an exemplary embodiment.

FIG. 12 is a cross sectional view of a portion of the charging system showing the supply charging device partially mated to the receive charging device in accordance with an exemplary embodiment.

FIG. 13 is a cross sectional view of a portion of the charging system showing the supply charging device unmated from the receive charging device and being removed from the receive charging device in accordance with an exemplary embodiment.

FIG. 14 is a front perspective view illustrating the receive charging device in accordance with an exemplary embodiment.

FIG. 15 is a cross sectional view of a portion of the receive charging device in accordance with an exemplary embodiment.

FIG. 16 is a cross sectional view of a portion of the charging system showing the supply charging device mated to the receive charging device in accordance with an exemplary embodiment.

FIG. 17 is a front perspective view illustrating the receive charging device in accordance with an exemplary embodiment.

FIG. 18 is a cross sectional view of a portion of the receive charging device in accordance with an exemplary embodiment.

FIG. 19 illustrates the connector mating sensor assembly including a printed circuit board having an upper surface and a lower surface in accordance with an exemplary embodiment.

FIG. 20 illustrates an enlarged view of a portion of the receive charging device showing the connector mating sensor assembly in accordance with an exemplary embodiment.

FIG. 21 is a cross sectional view of a portion of the charging system showing the supply charging device fully mated to the receive charging device in accordance with an exemplary embodiment.

FIG. 22 is a cross sectional view of a portion of the charging system showing the supply charging device partially mated to the receive charging device in accordance with an exemplary embodiment.

FIG. 23 is a cross sectional view of a portion of the charging system showing the supply charging device unmated from the receive charging device and being removed from the receive charging device in accordance with an exemplary embodiment.

FIG. 24 is a front perspective view of the receive charging device in accordance with an exemplary embodiment.

FIG. 25 is a front perspective view illustrating the receive charging device in accordance with an exemplary embodiment.

FIG. 26 is a cross sectional view of a portion of the receive charging device in accordance with an exemplary embodiment.

### DETAILED DESCRIPTION OF THE INVENTION

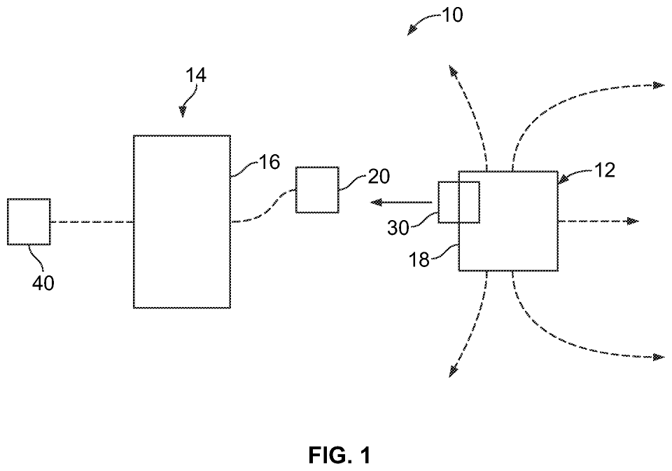

FIG. 1 illustrates a charging system 10 for charging a mobile device 12 in accordance with an exemplary embodiment. The charging system 10 includes a supply charging device 20 and a mobile charging device 30. The mobile charging device 30 is provided on the mobile device 12. The supply charging device 20 is provided on a charging component 14. The charging component 14 may extend from a wall outlet or charging station 16. The charging component 14 may be at a docketing station for the mobile device 12. The charging component 14 may include a charging plug at an end of a cable bundle that is plugged into the mobile charging device 30 to charge a battery of the mobile device 12. The charging component 14 may be provided in a room or building in a fixed location and the mobile device 12 may be movable within the room or building and returned to the vicinity of the charging station 16 for connection to the charging component 14 to recharge the mobile device 12. The supply charging device 20 receives power from a power supply 40.

In an exemplary embodiment, the mobile device 12 may be an electric vehicle that is movable within an environment to perform tasks and may return to the supply charging device 20 to charge the autonomous mobile device 12. In various embodiments, the mobile device 12 may be a forktruck. In other various embodiments, the mobile device 12 may be an autonomous mobile device, such as a mobile robot used to perform tasks in a factory, a hotel, a store or another environment. For example, the mobile robot may be used to scan items on shelves, deliver items from one location to another location, or perform other tasks. The mobile charging device 30 is mounted to a body 18 of the mobile device 12.

The mobile charging device 30 is a receive charging device 30 configured to receive power from the supply charging device 20. In an exemplary embodiment, the receive charging device 30 includes a connector mating sensor assembly 50 configured to be operably coupled to a supply power connector of the supply charging device 20 to indicate a mating status. The mating status is a mating status of a receive power connector of the receive charging device 30 with the supply power connector. In an exemplary embodiment, the mating status is one of a connected mating status when the supply power connector is mated or connected with the receive power connector or a disconnected mating status when the supply power connector is unmated or disconnected from the receive power connector. In an exemplary embodiment, operation of the mobile device 12 may be controlled based on the mating status. For example, during the connected mating status, the mobile device 12 may be unable to move. For example, the electric motor may be unable to operate when in the connected mating status. The mobile device 12 may be able to move only when the connector mating sensor assembly 50 is in the disconnected status.

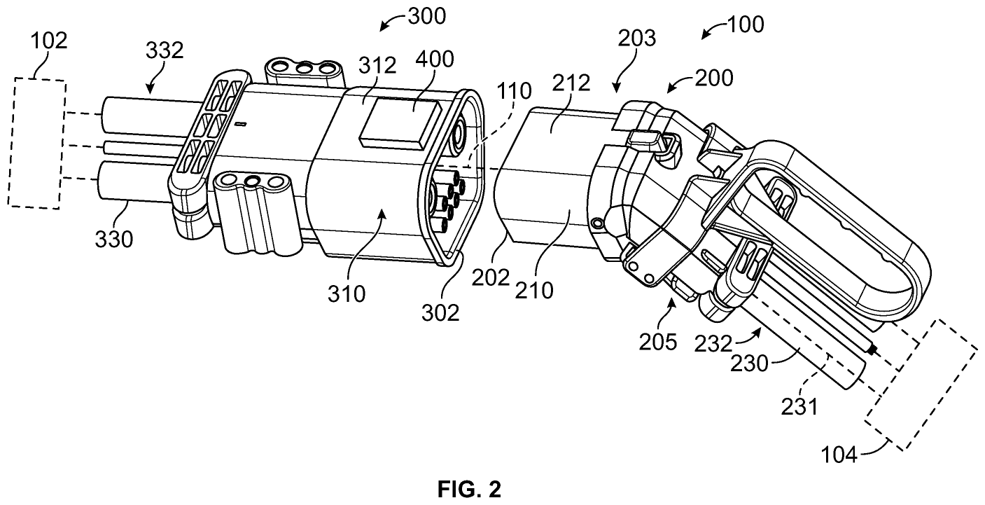

FIG. 2 illustrates a charging system 100 for charging a mobile device 102 in accordance with an exemplary embodiment. The charging system 100 includes a supply charging device 200 and a mobile charging device 300. The mobile charging device 300 receives power from the supply charging device 200 when coupled thereto to charge a battery of the mobile device 102. The mobile charging device 300 is a receive charging device, and may be referred to hereinafter as a receive charging device 300, configured to receive power from the supply charging device 20. FIG. 2 shows an angled version of the supply charging device 200, wherein the power cables are oriented transverse or non-parallel to a mating axis 110. In an alternative embodiment, the supply charging device 200 may be a straight version of the supply charging device 200, wherein the power cables are oriented parallel to a mating axis 110.

The receive charging device 300 is provided on the mobile device 102 and includes a mating end 302 configured to be mated with the supply charging device 200. For example, the receive charging device 300 is configured to be coupled to a body or panel of the mobile device 102. The supply charging device 200 is part of a charging component 104 and includes a mating end 202 configured to be mated with the receive charging device 300. The mating end 202 of the supply charging device 200 is configured to be plugged into the mating end 302 of the receive charging device 300.

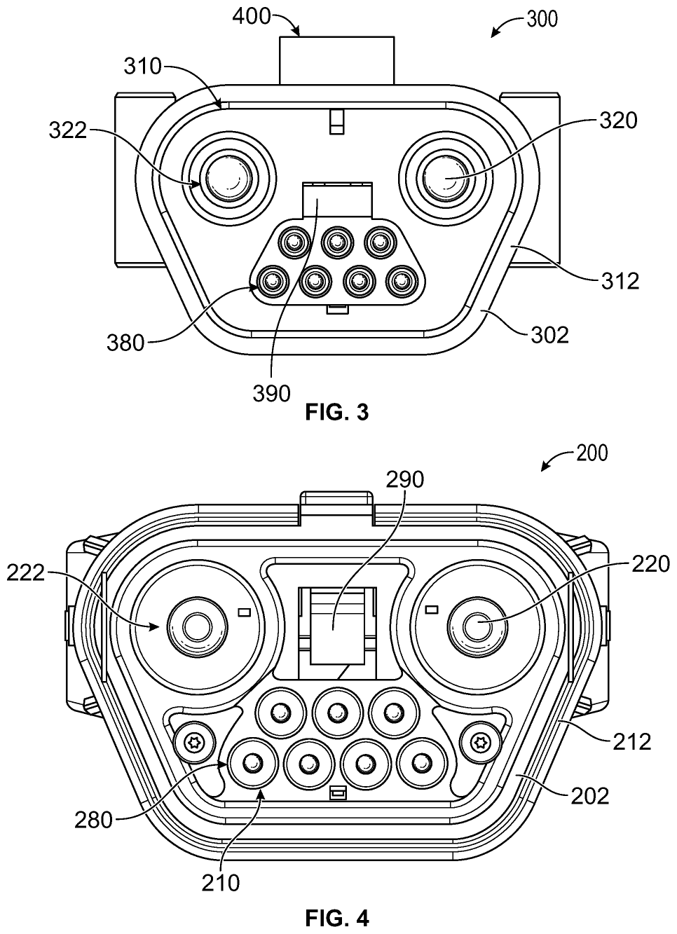

With additional reference to FIGS. 3 and 4, FIGS. 3 and 4 show front views of the receive charging device 300 and the supply charging device 200, respectively. The receive charging device 300 (FIG. 3) includes a receive power connector 310 having a receive housing 312. The receive housing 312 includes a latching feature 390 to secure the supply charging device 200 to the receive charging device 300. The receive power connector 310 includes a receive contact assembly 322 having a plurality of receive power contacts 320. The receive contact assembly 322 is coupled to the receive housing 312. The receive power connector 310 includes a cable assembly 332 having a plurality of receive power cables 330 terminated to the corresponding receive power contacts 320.

The supply charging device 200 (FIG. 4) includes a supply power connector 210 having a supply housing 212. The supply housing 212 includes a latching feature 290 to secure the supply charging device 200 to the receive charging device 300. The supply power connector 210 includes a supply contact assembly 222 having a plurality of supply power contacts 220. The supply contact assembly 222 is coupled to the supply housing 212. The supply power connector 210 includes a cable assembly 232 having a plurality of supply power cables 230 terminated to the corresponding supply power contacts 220.

The mating end 202 of the supply charging device 200 is coupled to the mating end 302 of the receive charging device 300 along the mating axis 110. For example, the mating end 202 is plugged into a receptacle 350 at the mating end 302. The supply power connector 210 is mated with the receive power connector 310. For example, the supply contacts of the supply contact assembly 222 are mated with the receive contacts of the receive contact assembly 322. In the illustrated embodiment, the supply contacts are pin contacts and the receive contacts are socket contacts; however, other types of contacts may be used in alternative embodiments. When mated, signal contacts 280 of the supply charging device 200 are mated with the corresponding signal contacts 380 of the receive charging device 300. When mated, the latching feature 290 of the supply charging device 200 is coupled to the latching feature 390 of the receive charging device 300 to securely couple the supply charging device 200 to the receive charging device 300.

In an exemplary embodiment, the receive charging device 300 includes a connector mating sensor assembly 400 configured to be operably coupled to the supply power connector 210 of the supply charging device 200 to indicate a mating status of the devices 200, 300. The mating status is a mating status of the receive power connector 310 with the supply power connector 210. In an exemplary embodiment, the mating status is one of a connected mating status when the supply power connector 210 is mated or connected with the receive power connector 310 or a disconnected mating status when the supply power connector 210 is unmated or disconnected from the receive power connector 310. In an exemplary embodiment, operation of the mobile device 102 may be controlled by the connector mating sensor assembly 400 based on the mating status. For example, when the mating status is a connected mating status, the mobile device 102 may be unable to move. For example, the electric motor may be unable to operate when in the connected mating status. The mobile device 102 may be able to move only when the connector mating sensor assembly 400 is in the disconnected mating status.

In an exemplary embodiment, the connector mating sensor assembly 400 determines the mating status of the receive housing 312 with the supply housing 212 of the supply power connector 210. For example, the connector mating sensor assembly 400 determines when the supply housing 212 is removed from the receive housing 312 indicating that the supply charging device 200 has been fully disconnected from the receive charging device 300. In an exemplary embodiment, the connector mating sensor assembly 400 determines the mating status of the receive power connector 310 relative to the supply power connector 210 independent of a mating status of the receive power contacts relative to the supply power contacts. For example, because the power contacts are recessed inside the housings 212, 312, the power contacts unmate prior to the housings being unmated. The connector mating sensor assembly 400 determines when the housings are unmated and thus it is safe for the mobile device 102 to move without damaging the components of the supply charging device 200 or the receive charging device 300. In an exemplary embodiment, the connector mating sensor assembly 400 monitors the mating status at the front of the receive housing 312, such as to determine when the supply housing 212 is removed from the front of the receptacle 350 of the receive housing 312.

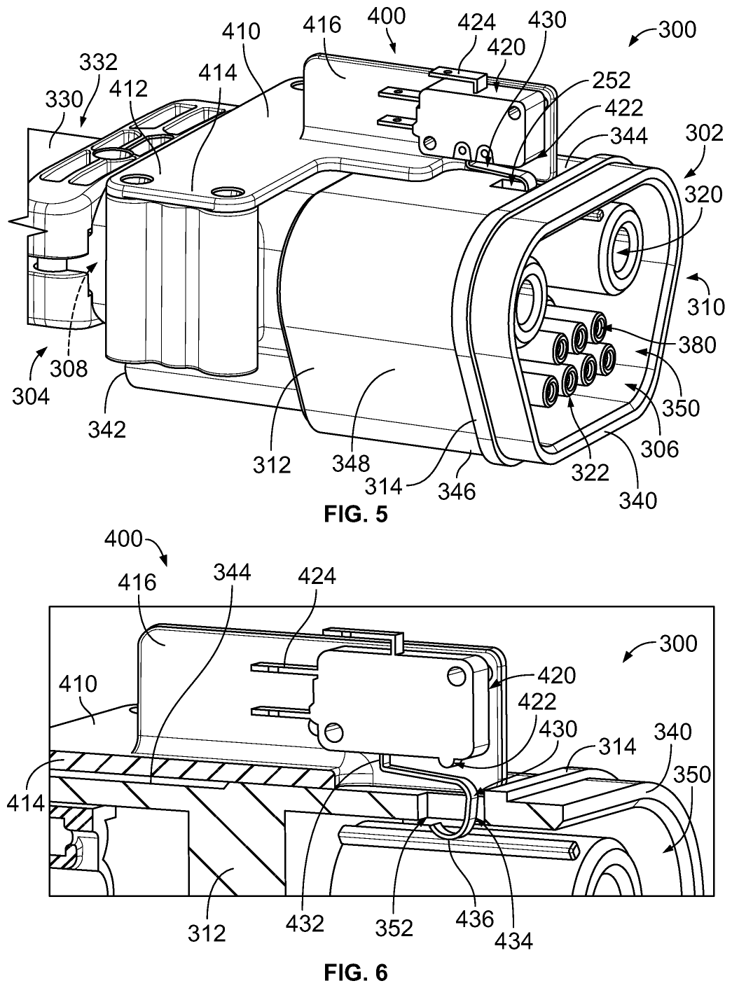

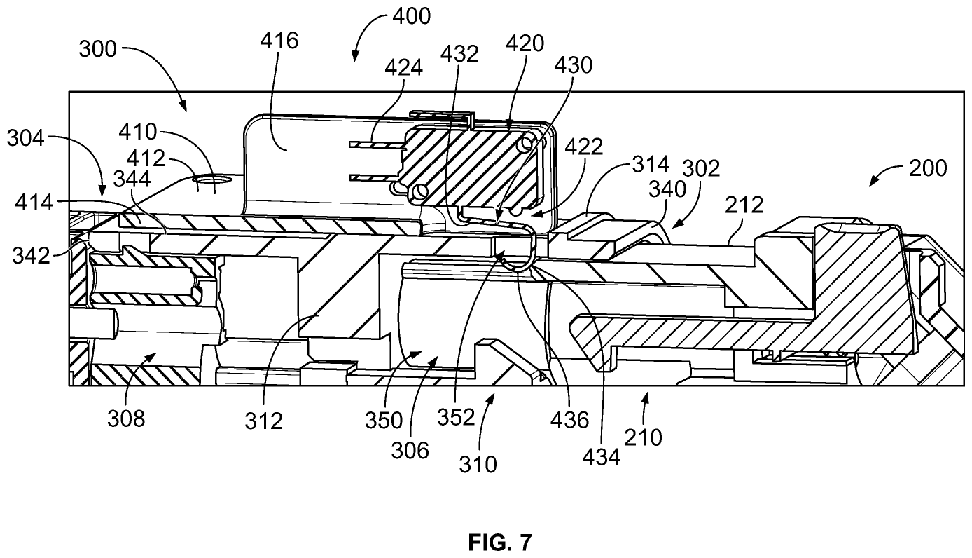

FIG. 5 is a front perspective view illustrating the receive charging device 300 in accordance with an exemplary embodiment. FIG. 6 is a cross sectional view of a portion of the receive charging device 300 in accordance with an exemplary embodiment. FIG. 7 is a cross sectional view of a portion of the charging system showing the supply charging device 200 partially mated to or partially unmated from the receive charging device 300. FIG. 7 shows the supply charging device 200 immediately before activation of the connector mating sensor assembly 400 or immediately after deactivation of the connector mating sensor assembly 400, depending on the direction of movement of the supply charging device 200.

The receive charging device 300 includes the receive power connector 310, the receive contact assembly 322, the receive cable assembly 332, and the connector mating sensor assembly 400. The receive power connector 310 includes the receive housing 312. In an exemplary embodiment, the connector mating sensor assembly 400 is mounted to an exterior of the receive housing 312. The connector mating sensor assembly 400 is configured to monitor presence of the supply charging device 200 in the receptacle 350 of the receive housing 312.

The receive housing 312 includes a front 340 and a rear 342. The receive housing 312 includes a top 344 and a bottom 346. The receive housing 312 includes sides 348 between the top 344 and the bottom 346. Optionally, the sides may be angled, such as being non-parallel to each other. For example, the top 344 may be wider than the bottom 346. In an exemplary embodiment, the receive housing 312 includes a flange 314 at the front 340, which may be used to secure the receive housing 312 to the mobile device. In an exemplary embodiment, the mating end 302 is at the front 340 of the receive housing 312 and a cable end 304 of the receive power connector 310 is at the rear 342 of the receive housing 312. The cables 330 enter/exit the receive housing 312 at the cable end 304.

In an exemplary embodiment, the receive housing 312 includes a receive contact chamber 306 that receives the receive power contacts 320 and a receive cable chamber 308 that receives the receive power cables 330. The receive contact chamber 306 is located at the front 340. The receive cable chamber 308 is located at the rear 342. The receive cable chamber 308 may be open at the rear 342 to receive the cables 330. In an exemplary embodiment, the receive power contact 320 is a socket contact.

The connector mating sensor assembly 400 is provided to determine the mating status of the receive power connector 210. For example, the connector mating sensor assembly 400 determines when the supply housing 212 (FIG. 7) is located in the receptacle 350 of the receive housing 312 and when the supply housing 212 is removed from the receptacle 350 of the receive housing 312. The connector mating sensor assembly 400 determines when the supply charging device 200 has been fully disconnected from the receive charging device 300. In an exemplary embodiment, the connector mating sensor assembly 400 is mounted to the exterior of the receive housing 312, such as to the top 344 of the receive housing 312. However, the connector mating sensor assembly 400 may be mounted to the receive housing 312 at other locations, such as at the bottom 346 or at one of the sides 348. A portion of the connector mating sensor assembly 400 may extend into the interior of the receptacle 350, such as to interface with the supply housing 212. In an exemplary embodiment, the receive housing 312 includes a window 352 therethrough providing access to the receptacle 350. A portion of the connector mating sensor assembly 400 passes through the window 352 into the receptacle 350.

In an exemplary embodiment, the connector mating sensor assembly 400 includes a carrier 410. The carrier 410 may be mounted to the receive housing 312, such as using fasteners. In various embodiments, the carrier 410 includes a mounting bracket 412 secured to the receive housing 312 using fasteners. The carrier 410 may include a planar base 414 extending along the exterior of the receive housing 312, such as along the top 344. The carrier 410 may include one or more support walls 416 extending from the base 414. The support walls 416 may be used to support various components of the connector mating sensor assembly 400. In various embodiments, the connector mating sensor assembly 400 may include a cover (not shown) coupled to the carrier 410. The cover is used to cover various components of the connector mating sensor assembly 400, such as to protect the components from the environment, such as from dirt, debris, moisture, and the like.

In an exemplary embodiment, the connector mating sensor assembly 400 includes a connector mating sensor 420 used to sense or monitor the mating status of the receive charging device 300. The connector mating sensor 420 may be used as part of a control system for the mobile device 102, such as a safety interlock to restrict/allow control or operation of the mobile device based on the mating status (for example, connected/disconnected) of the receive charging device 300. For example, the connector mating sensor 420 may be wired to a control relay, a motor contactor control circuit, or as an input to a programmable logic controller. The connector mating sensor 420 may be mounted to the carrier 410. In other various embodiments, the connector mating sensor 420 may be directly mounted to the receive housing 312.

In an exemplary embodiment, the connector mating sensor 420 includes a switch element 422. The switch element 422 may switch between different states, such as a first state and a second state. The first state may be an open state forming an open circuit and the second state may be a closed state forming a closed circuit. The switch element 422 may a normally open switch forming an open circuit when the receive charging device 300 is disconnected from the supply charging device 200. The switch element 422 may change state, for example form a closed circuit, when the supply charging device 200 is mated with (for example, plugged into) the receive charging device 300. In an exemplary embodiment, the switch element 422 is a limit switch. The switch element 422 may include a button, a lever, a roller, a plunger, a whisker, or other type of activation element. The activation element may be a snap-action switch. The limit switch can be used in rugged environments. The limit switch has ease of installation. The limit switch has reliable operation and can be operated over many cycles, such as over 10,000 mating cycles. Other types of sensors may be used in alternative embodiments, such as proximity sensors, a reed switch, pogo-pin sensors, or other types of sensors.

In an exemplary embodiment, the connector mating sensor 420 includes one or more terminals or leads 424 for connection to wires, a connector, a controller, a printed circuit board, or other electrical component. In various embodiments, the connector mating sensor 420 may include three leads, such as a common lead, a normally open lead, and a normally closed lead. The connector mating sensor 420 may include a movable contact (not shown) in the switch body that is movable between the normally open lead and the normally closed lead when the switch is activated and deactivated.

In an exemplary embodiment, the connector mating sensor 420 includes an actuator 430 operably coupled to the switch element 422. The actuator 430 is movable relative to the switch body. The actuator 430 is used to activate and deactivate the switch element 422 based on the mating status of the receive charging device 300. The actuator 430 is configured to be located in the receptacle 350 to interface with the supply housing 212 when the supply charging device 200 is in the receptacle 350 to activate the switch element 422 indicating a connected mating status. The actuator 430 is configured to be released from the supply housing 212 when the supply charging device 200 is removed from the receptacle 350 to deactivate the switch element 422 indicating a disconnected mating status. In an exemplary embodiment, the actuator 430 is pivotable between an actuated position and a released position. The actuator 430 activates the switch element 422 in the actuated position. The switch element 422 is deactivated when the actuator 430 is in the released position.

The actuator 430 extends between a first end 432 and a second end 434. The first end 432 is located at the switch element 422. For example, the first end 432 may be mounted to the switch body of the connector mating sensor 420. The first end 432 may be used to activate the switch element 422. The second end 434 is configured to interface with the supply charging device 200. For example, the actuator 430 may extend into the window 352 into the interior of the receive housing 312 proximate to the front 340 of the receive housing 312. In an exemplary embodiment, the actuator 430 includes an engagement tip 436 at the second end 434 configured to engage the supply housing 212 when the supply charging device 200 is plugged into the receptacle 350. In an exemplary embodiment, the actuator 430 is a metal beam that may be stamped and formed into a predetermined shape, such as to include a tab or finger extending through the window 352 into the receptacle 350. The actuator 430 is deflectable. For example, the actuator 430 may be flexed upward to activate the switch element 422 by the supply housing 212 when the supply charging device 200 is plugged into the receptacle 350.

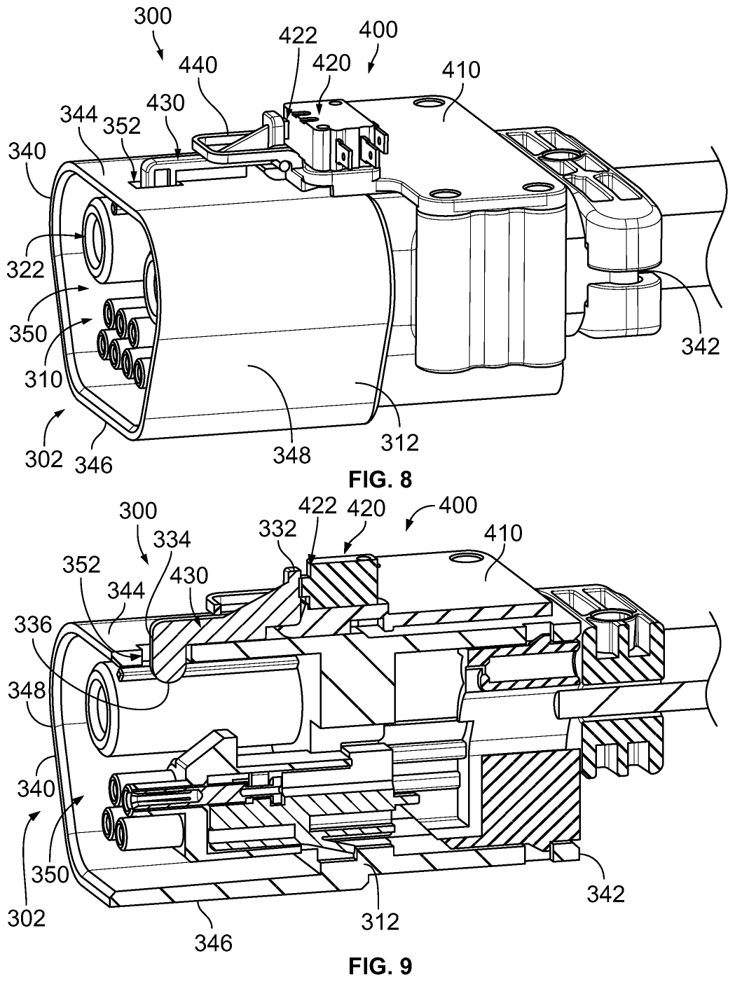

FIG. 8 is a front perspective view illustrating the receive charging device 300 in accordance with an exemplary embodiment. FIG. 9 is a cross sectional view of a portion of the receive charging device 300 in accordance with an exemplary embodiment. FIGS. 8 and 9 show the connector mating sensor assembly 400 in a different orientation. FIGS. 8 and 9 show the connector mating sensor assembly 400 having a different type of actuator 430, such as a pivot lever.

The receive charging device 300 includes the receive power connector 310, the receive contact assembly 322, the receive cable assembly 332, and the connector mating sensor assembly 400. The receive power connector 310 includes the receive housing 312 having the receptacle 350. The connector mating sensor assembly 400 is mounted to an exterior of the receive housing 312, such as the top 344 of the receive housing 312. For example, the carrier 410 is mounted to the receive housing 312.

The receive housing 312 includes the front 340, the rear 342, the top 344, the bottom 346, and the sides 348. The receptacle 350 is open at the mating end 302, such as at the front 340, to receive the supply charging device 200 (shown in FIG. 2). The connector mating sensor assembly 400 extends into the receptacle 350 to interface with the supply charging device 200. For example, the actuator 430 of the connector mating sensor assembly 400 passes through the window 352 into the receptacle 350. The connector mating sensor assembly 400 determines the mating status of the receive power connector 210 by determining when the supply housing 212 is located in the receptacle 350 and when the supply housing 212 is removed from the receptacle 350 of the receive housing 312.

The connector mating sensor assembly 400 includes the connector mating sensor 420 to sense or monitor the mating status of the receive charging device 300. In the illustrated embodiment, the connector mating sensor 420 includes the switch element 422 configured to control an operating circuit. The switch element 422 may be a limit switch.

The connector mating sensor 420 includes the actuator 430 operably coupled to the switch element 422. The actuator 430 may be a molded part. In an exemplary embodiment, the actuator 430 is pivotably coupled to the carrier 410. The actuator 430 is pivotable between an actuated position and a released position. The actuator 430 is movable (for example, pivots) relative to the switch body of the connector mating sensor 420. In an exemplary embodiment, the connector mating sensor assembly 400 includes a biasing element 440 engaging the actuator 430 and forcing the actuator 430 toward the released position. The biasing element 440 may be a spring arm extending from the carrier 410 to interface with the actuator 430. The biasing element 440 may be integral with the carrier 410, such as being co-molded with the carrier 410. In the illustrated embodiment, the biasing element 440 presses downward on the actuator 430 to pivot the second end 434 downward into the receptacle to interface with the supply housing 212. The first end 432 of the actuator 430 is configured to engage and activate the switch element 422 based on the mating status of the receive charging device 300. The second end 434 of the actuator 430 extends through the window 352 and is located in the receptacle 350 to interface with the supply housing 212 when the supply charging device 200 is in the receptacle 350 to activate the switch element 422 indicating a connected mating status. The engagement tip 436 at the second end 434 is configured to engage the supply housing 212 when the supply charging device 200 is plugged into the receptacle 350 to rotate the actuator 430 to the actuated position. The actuator 430 is configured to be released from the supply housing 212 when the supply charging device 200 is removed from the receptacle 350 to deactivate the switch element 422 indicating a disconnected mating status.

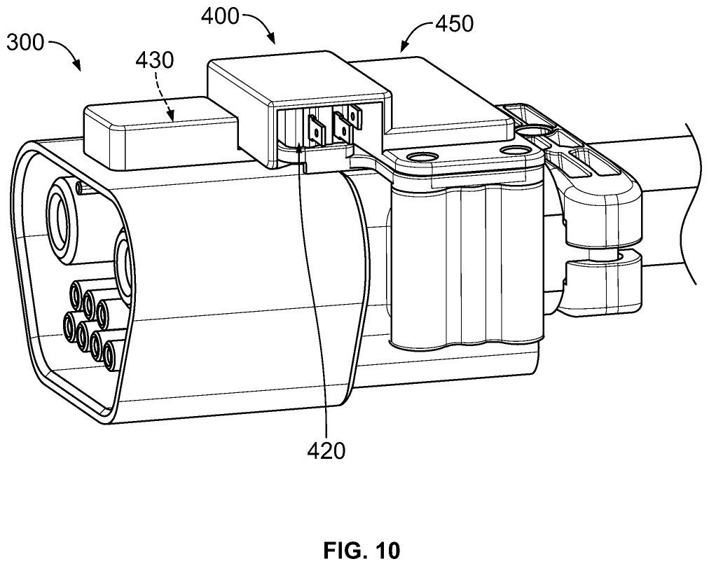

FIG. 10 is a front perspective view of the receive charging device 300 in accordance with an exemplary embodiment. In an exemplary embodiment, the connector mating sensor assembly 400 includes a cover 450 coupled to the carrier 410. The cover 450 covers the various components of the connector mating sensor assembly 400, such as the connector mating sensor 420 and the actuator 430. The cover 450 protects the components from the environment, such as from dirt, debris, moisture, and the like.

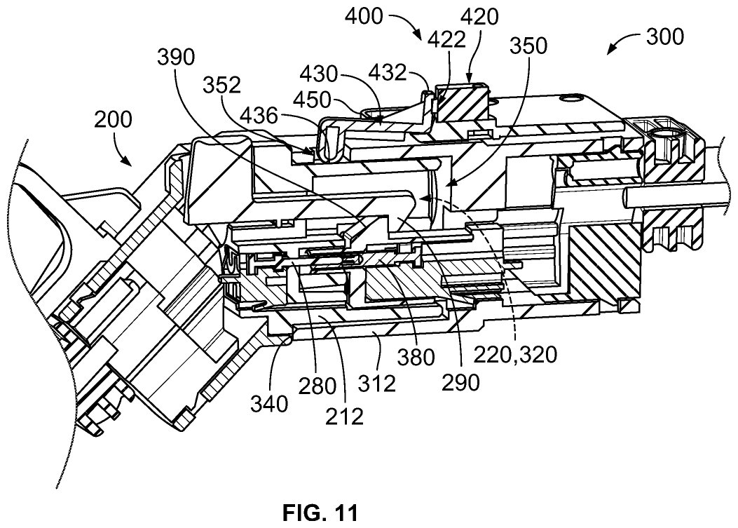

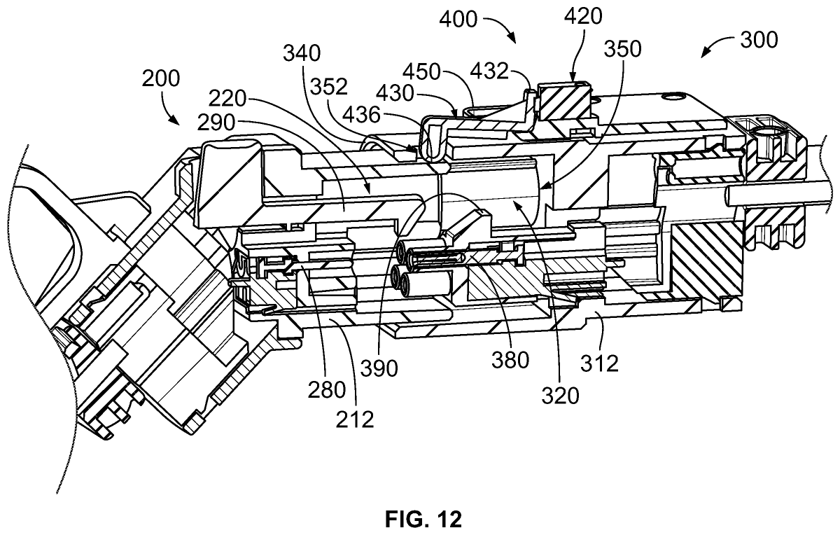

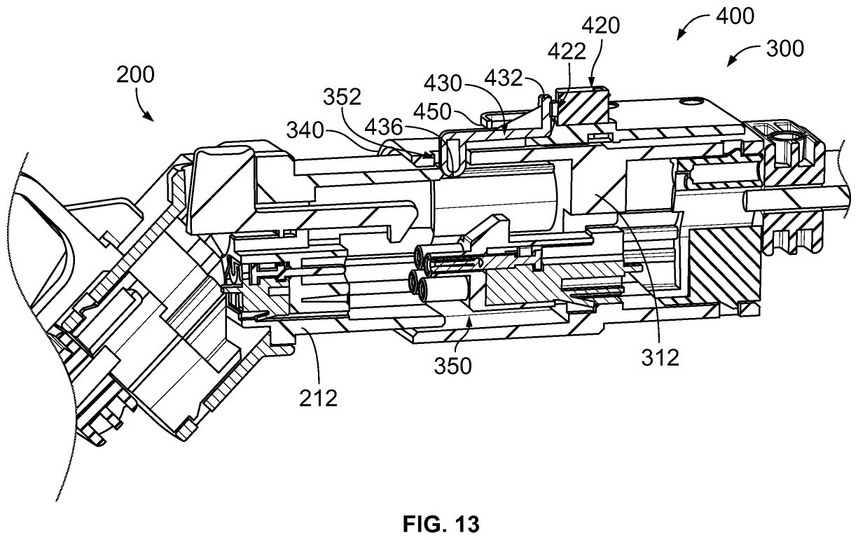

FIG. 11 is a cross sectional view of a portion of the charging system showing the supply charging device 200 fully mated to the receive charging device 300. FIG. 12 is a cross sectional view of a portion of the charging system showing the supply charging device 200 partially mated to the receive charging device 300. FIG. 13 is a cross sectional view of a portion of the charging system showing the supply charging device 200 unmated from the receive charging device 300 and being removed from the receive charging device 300.

The connector mating sensor assembly 400 is configured to monitor presence of the supply charging device 200 in the receptacle 350 of the receive housing 312. The connector mating sensor assembly 400 determines when the supply housing 212 is located in the receptacle 350 of the receive housing 312 and when the supply housing 212 is removed from the receptacle 350 of the receive housing 312. The connector mating sensor assembly 400 determines when the supply charging device 200 has been fully disconnected from the receive charging device 300 (FIG. 13).

When the supply charging device 200 is fully loaded into the receptacle 350 (FIG. 11), the actuator 430 engages the supply housing 212 and is deflected or actuated outward to activate the switch element 422. For example, the supply housing 212 engages the engagement tip 436 when the supply housing 212 is loaded into the receptacle 350 to force the actuator 430 outward to the actuated position. The first end 432 is pivoted to activate the switch element 422 indicating a connected mating status, corresponding to the supply charging device 200 being connected to the receive charging device 300 and thus it being unsafe to allow the mobile device 102 to move. In the mated position, the signal contacts 280 of the supply charging device 200 are mated with the corresponding signal contacts 380 of the receive charging device 300. Similarly, the supply power contacts 220 are mated with the corresponding receive power contacts 320. In the mated position, the latching feature 290 of the supply charging device 200 is mated with the latching feature 390 of the receive charging device 300.

During unmating, the supply charging device 200 is pulled rearward to remove the supply charging device 200 from the receptacle 350 of the receive charging device 300. During unmating, the signal contacts 280 are unmated from the signal contacts 380 and the supply power contacts 220 are unmated from the receive power contacts 320. When partially unmated (FIG. 12), even when the contacts are unmated, the supply housing 212 is still located in the receive housing 312. If the mobile device 102 were to move when the charging devices 200, 300 are partially unmated (not fully unmated), the components of the charging devices 200, 300 may be damaged. In an exemplary embodiment, when the charging devices 200, 300 are partially unmated, the actuator 430 remains engaged with the supply housing 212, thus remaining in the deflected or actuated position to maintain the switch element 422 in the activated state indicating that the charging devices 200, 300 are still in the connected mating status.

When unmated or disconnected (FIG. 13), the supply housing 212 is removed from the front 340 of the receive housing 312. The supply housing 212 releases the actuator 430. The actuator 430 disengages from the supply housing 212 and is allowed to move or pivot downward to the released position. The biasing element 440 forces the actuator 430 to return to the released position. When the actuator 430 is moved to the released position, the first end 432 moves away from the switch element 422 to deactivate the connector mating sensor 420 indicating a disconnected mating status. In an exemplary embodiment, the window 352, and thus the engagement tip 436 of the actuator 430, are located proximate to (at or near) the front 340 of the receive housing 312. As such, the actuator 430 is released only when the supply housing 212 is moved to the receptacle exit at the front 340 of the receive housing 312 indicating disconnection of the charging devices 200, 300.

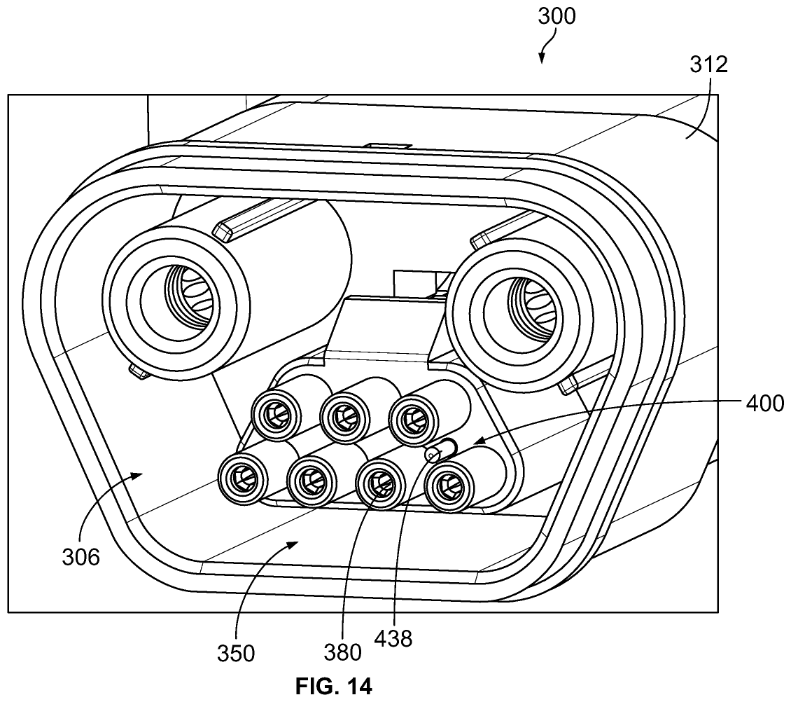

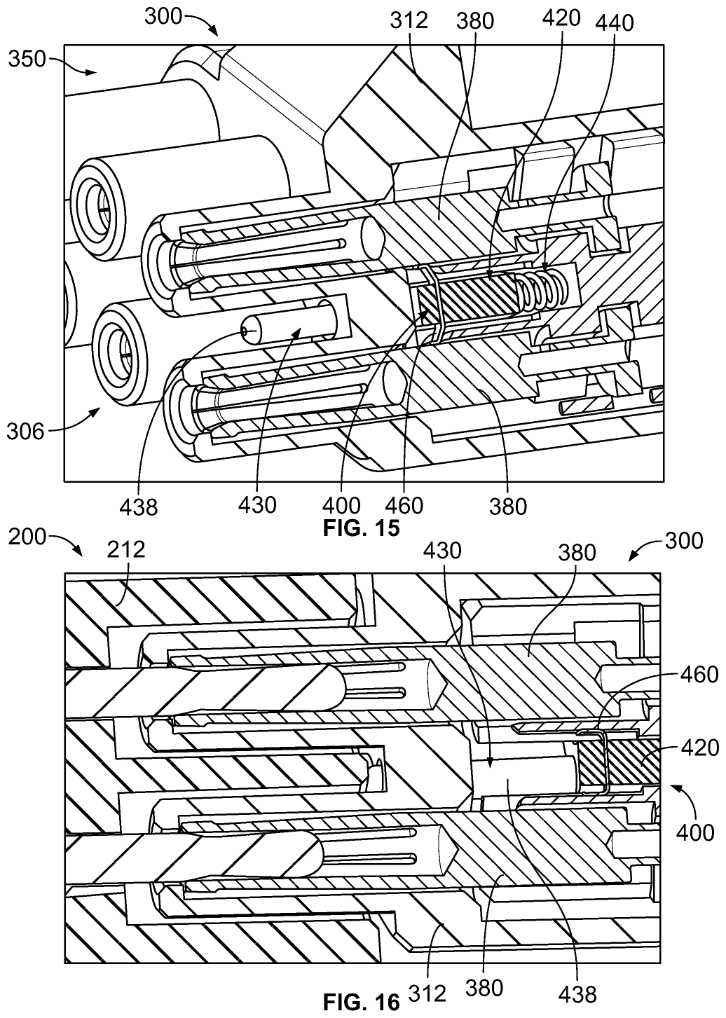

FIG. 14 is a front perspective view illustrating the receive charging device 300 in accordance with an exemplary embodiment. FIG. 15 is a cross sectional view of a portion of the receive charging device 300 in accordance with an exemplary embodiment. FIG. 16 is a cross sectional view of a portion of the charging system showing the supply charging device 200 mated to the receive charging device 300. FIGS. 14-16 show a different type of connector mating sensor assembly 400 in a different location.

In the illustrated embodiment, the connector mating sensor assembly 400 is located interior of the receive housing 312. For example, the connector mating sensor assembly 400 is located in the contact chamber 306, such as in the area of the signal contacts 380. In an exemplary embodiment, the connector mating sensor 420 of the connector mating sensor assembly 400 includes a shorting contact 460 (FIGS. 15 and 16) configured to create a short between two of the signal contacts 380, such as when the charging devices 200, 300 are disconnected. In an exemplary embodiment, the actuator 430 includes a pin or plunger 438 configured to pass through a wall of the receive housing 312 to interface with the supply charging device 200. The biasing element 440 is a spring member, such as a coil spring, configured to forward bias the plunger 438.

When the supply charging device 200 is fully loaded into the receptacle 350 (FIG. 16), the actuator 430 engages the supply housing 212 and is deflected or actuated inward to activate a control signal. The shorting contact 460 is pressed inward into a pocket in the wall to disengage from the signal contacts 380, opening the short circuit path. For example, a control system may monitor the short circuit path between the signal contacts 380. When the short circuit path is open, the system indicates a connected mating status, corresponding to the supply charging device 200 being connected to the receive charging device 300 and thus it being unsafe to allow the mobile device 102 to move.

When unmated or disconnected (FIG. 15), the supply housing 212 is removed from the receive housing 312. The actuator 430 is released and allowed to move to the normal, forward biased position. In the released position, the shorting contact 460 engages the signal contacts 380 and creates a short circuit path between the signal contacts 380. When the short circuit path is closed, the system indicates a disconnected mating status, corresponding to the supply charging device 200 being disconnected from the receive charging device 300 and thus it being safe to allow the mobile device 102 to move.

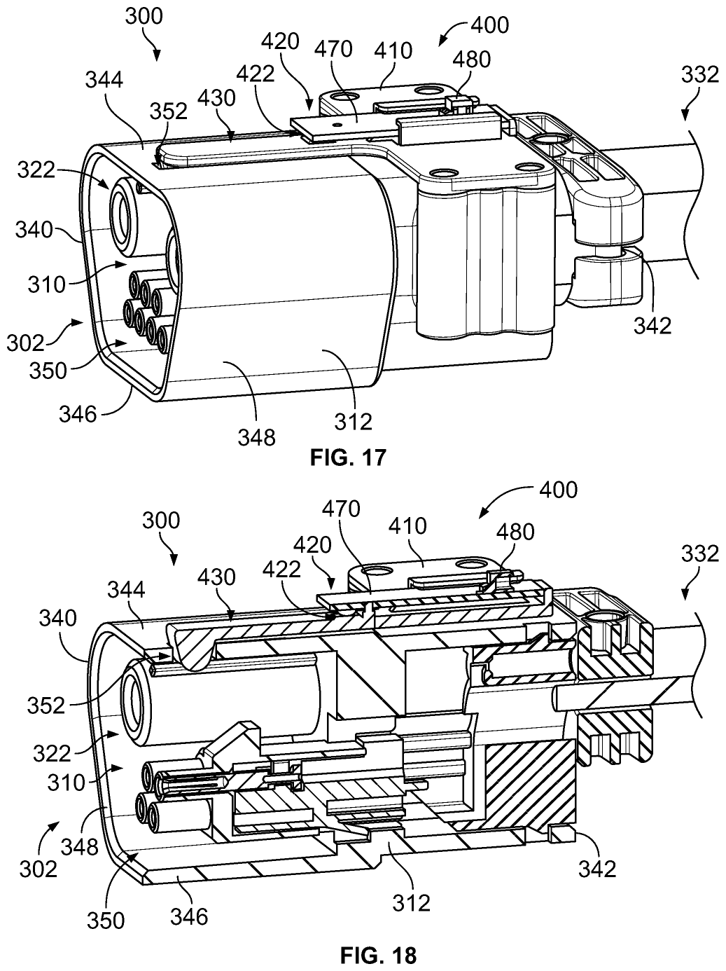

FIG. 17 is a front perspective view illustrating the receive charging device 300 in accordance with an exemplary embodiment. FIG. 18 is a cross sectional view of a portion of the receive charging device 300 in accordance with an exemplary embodiment. FIGS. 17 and 18 show the connector mating sensor assembly 400 in a different orientation compared to the embodiments shown in FIGS. 2-16. FIGS. 17 and 18 show the connector mating sensor assembly 400 having a different type of connector mating sensor 420. FIGS. 17 and 18 show the connector mating sensor assembly 400 having a different type of actuator 430.

The receive charging device 300 includes the receive power connector 310, the receive contact assembly 322, the receive cable assembly 332, and the connector mating sensor assembly 400. The receive power connector 310 includes the receive housing 312 having the receptacle 350. The connector mating sensor assembly 400 is mounted to an exterior of the receive housing 312, such as the top 344 of the receive housing 312. For example, the carrier 410 is mounted to the receive housing 312

The receive housing 312 includes the front 340, the rear 342, the top 344, the bottom 346, and the sides 348. The receptacle 350 is open at the mating end 302, such as at the front 340, to receive the supply charging device 200 (shown in FIG. 2). The connector mating sensor assembly 400 extends into the receptacle 350 to interface with the supply charging device 200. For example, the actuator 430 of the connector mating sensor assembly 400 passes through the window 352 into the receptacle 350. The connector mating sensor assembly 400 determines the mating status of the receive power connector 210 by determining when the supply housing 212 is located in the receptacle 350 and when the supply housing 212 is removed from the receptacle 350 of the receive housing 312.

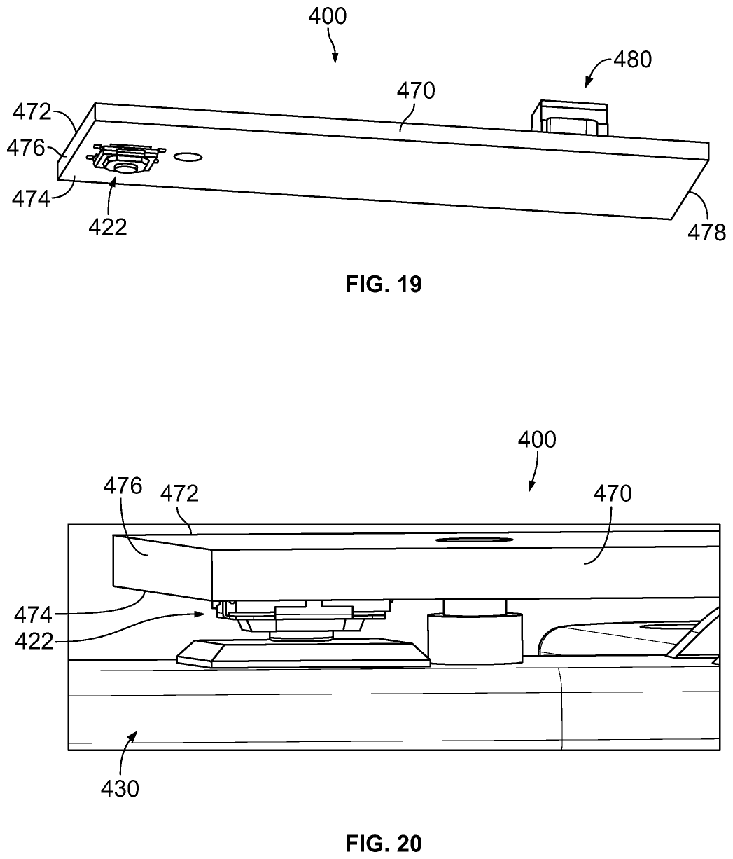

With additional reference to FIG. 19, the connector mating sensor assembly 400 includes a printed circuit board 470 having an upper surface 472 and a lower surface 474. The printed circuit board 470 extends between a first end 476 and a second end 478. The connector mating sensor assembly 400 includes the connector mating sensor 420 to sense or monitor the mating status of the receive charging device 300. In the illustrated embodiment, the connector mating sensor 420 includes the switch element 422 configured to control an operating circuit. The switch element 422 may be a limit switch. In an exemplary embodiment, the switch element 422 is mounted to the printed circuit board 470. For example, the switch element 422 may be mounted to the lower surface 474 facing the actuator 430. The switch element 422 may be located proximate to the first end 476. In an exemplary embodiment, the connector mating sensor assembly 400 includes an electrical connector 480 mounted to the printed circuit board 470. The electrical connector 480 is electrically connected to the switch element 422 by conductors or traces of the printed circuit board 470. The electrical connector 480 may be coupled to a plug connector.

With additional reference to FIG. 20, which is an enlarged view of a portion of the receive charging device 300 showing the connector mating sensor assembly 400 in accordance with an exemplary embodiment, the connector mating sensor 420 includes the actuator 430 operably coupled to the switch element 422. The actuator 430 may be a molded part. In an exemplary embodiment, the actuator 430 may be integral with the carrier 410, such as being co-molded with the carrier 410. The actuator 430 is pivotable between an actuated position and a released position. The actuator 430 is movable relative to the switch element 422. For example, the actuator 430 may pivot upward to activate the switch element 422. The first end 432 of the actuator 430 is configured to engage and activate the switch element 422 based on the mating status of the receive charging device 300. The second end 434 of the actuator 430 extends through the window 352 and is located in the receptacle 350 to interface with the supply housing 212 when the supply charging device 200 is in the receptacle 350 to activate the switch element 422 indicating a connected mating status. The engagement tip 436 at the second end 434 is configured to engage the supply housing 212 when the supply charging device 200 is plugged into the receptacle 350 to rotate the actuator 430 to the actuated position. The actuator 430 is configured to be released from the supply housing 212 when the supply charging device 200 is removed from the receptacle 350 to deactivate the switch element 422 indicating a disconnected mating status.

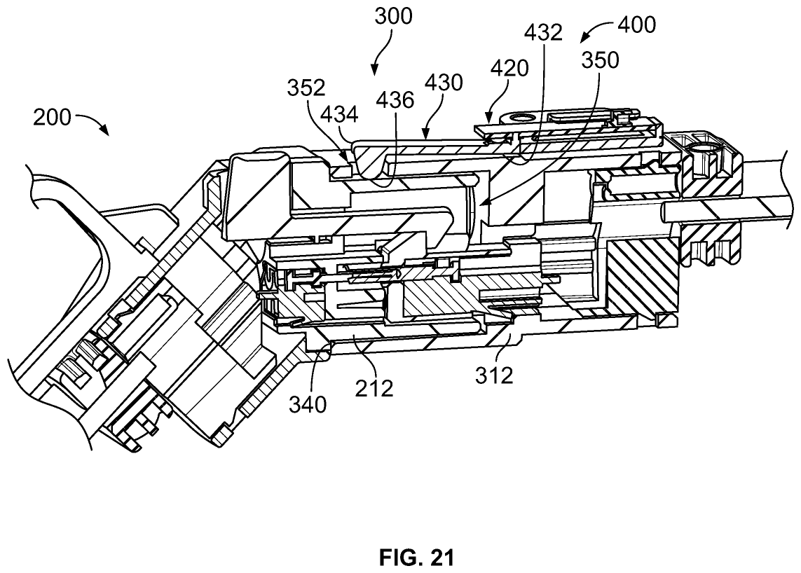

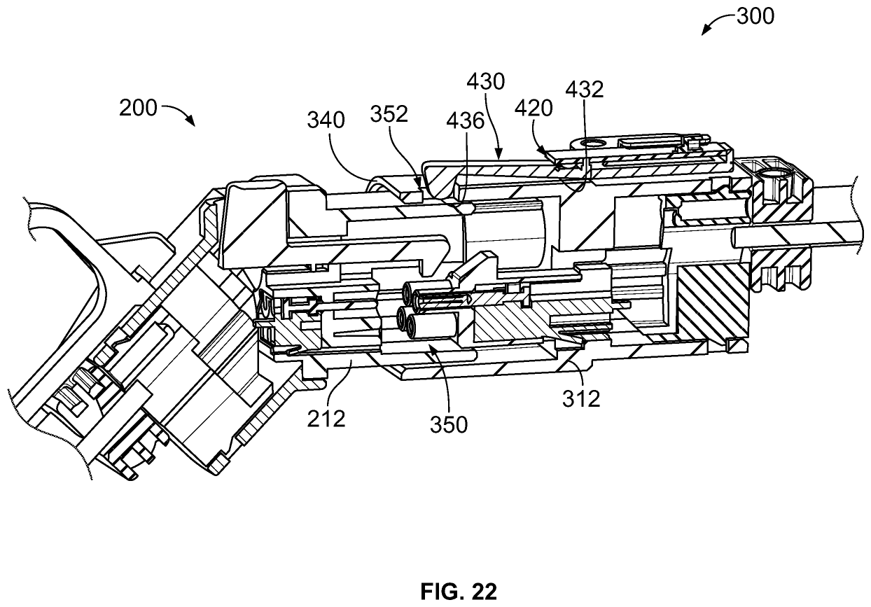

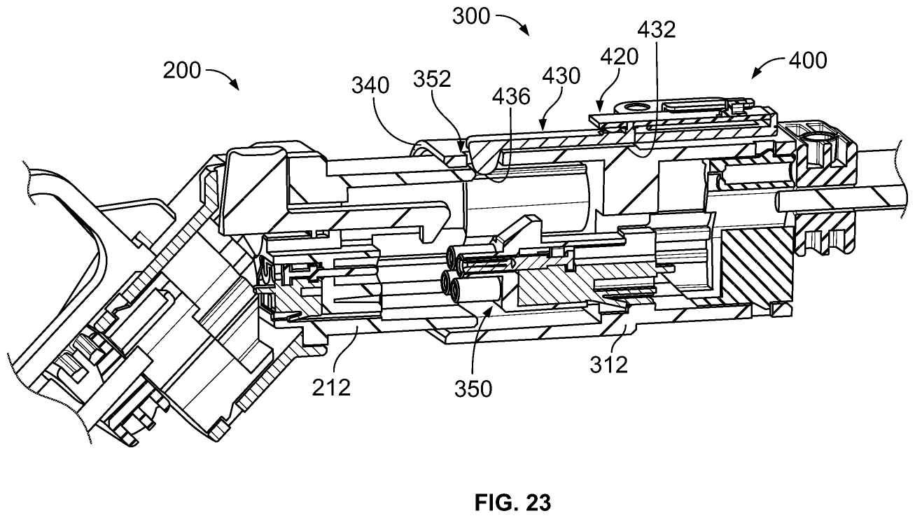

FIG. 21 is a cross sectional view of a portion of the charging system showing the supply charging device 200 fully mated to the receive charging device 300. FIG. 22 is a cross sectional view of a portion of the charging system showing the supply charging device 200 partially mated to the receive charging device 300. FIG. 23 is a cross sectional view of a portion of the charging system showing the supply charging device 200 unmated from the receive charging device 300 and being removed from the receive charging device 300.

The connector mating sensor assembly 400 is configured to monitor presence of the supply charging device 200 in the receptacle 350 of the receive housing 312. The connector mating sensor assembly 400 determines when the supply housing 212 is located in the receptacle 350 of the receive housing 312 and when the supply housing 212 is removed from the receptacle 350 of the receive housing 312. The connector mating sensor assembly 400 determines when the supply charging device 200 has been fully disconnected from the receive charging device 300 (FIG. 13).

When the supply charging device 200 is fully loaded into the receptacle 350 (FIG. 21), the actuator 430 engages the supply housing 212 and is deflected or actuated outward to activate the switch element 422. For example, the supply housing 212 engages the engagement tip 436 when the supply housing 212 is loaded into the receptacle 350 to force the actuator 430 outward to the actuated position. The first end 432 is elevated to activate the switch element 422 indicating a connected mating status, corresponding to the supply charging device 200 being connected to the receive charging device 300 and thus it being unsafe to allow the mobile device 102 to move.

During unmating, the supply charging device 200 is pulled rearward to remove the supply charging device 200 from the receptacle 350 of the receive charging device 300. When partially unmated (FIG. 22), even when the contacts are unmated, the supply housing 212 is still located in the receive housing 312. If the mobile device 102 were to move when the charging devices 200, 300 are partially unmated (not fully unmated), the components of the charging devices 200, 300 may be damaged. In an exemplary embodiment, when the charging devices 200, 300 are partially unmated, the actuator 430 remains engaged with the supply housing 212, thus remaining in the deflected or actuated position to maintain the switch element 422 in the activated state indicating that the charging devices 200, 300 are still in the connected mating status.

When unmated or disconnected (FIG. 23), the supply housing 212 is removed from the front 340 of the receive housing 312. The supply housing 212 releases the actuator 430. The actuator 430 disengages from the supply housing 212 and is allowed to move or pivot downward to the released position. The biasing element 440 forces the actuator 430 to return to the released position. When the actuator 430 is moved to the released position, the first end 432 moves away from the switch element 422 to deactivate the connector mating sensor 420 indicating a disconnected mating status. In an exemplary embodiment, the window 352, and thus the engagement tip 436 of the actuator 430, are located proximate to (at or near) the front 340 of the receive housing 312. As such, the actuator 430 is released only when the supply housing 212 is moved to the receptacle exit at the front 340 of the receive housing 312 indicating disconnection of the charging devices 200, 300.

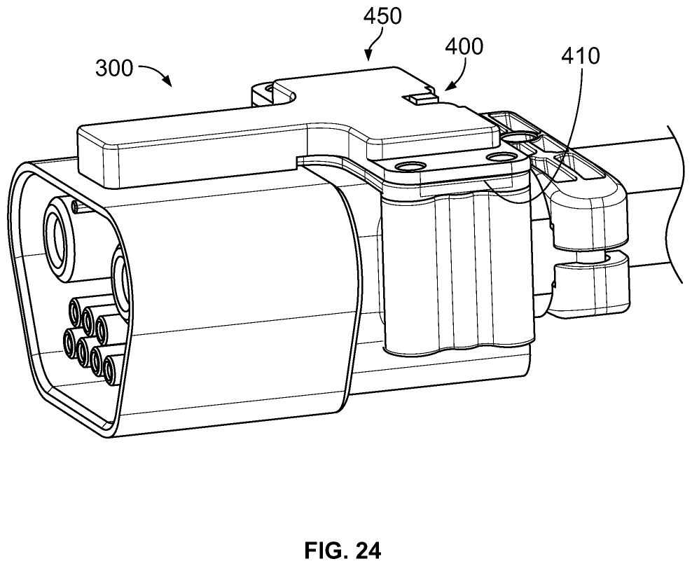

FIG. 24 is a front perspective view of the receive charging device 300 in accordance with an exemplary embodiment. In an exemplary embodiment, the connector mating sensor assembly 400 includes the cover 450 coupled to the carrier 410. The cover 450 covers the various components of the connector mating sensor assembly 400, such as the connector mating sensor 420, the actuator 430, and the printed circuit board 470. The cover 450 protects the components from the environment, such as from dirt, debris, moisture, and the like.

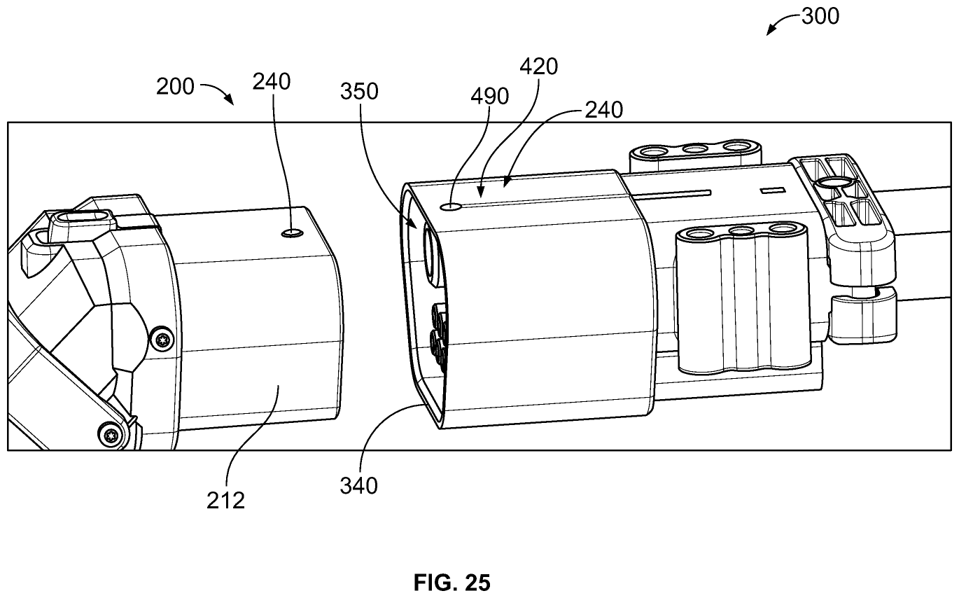

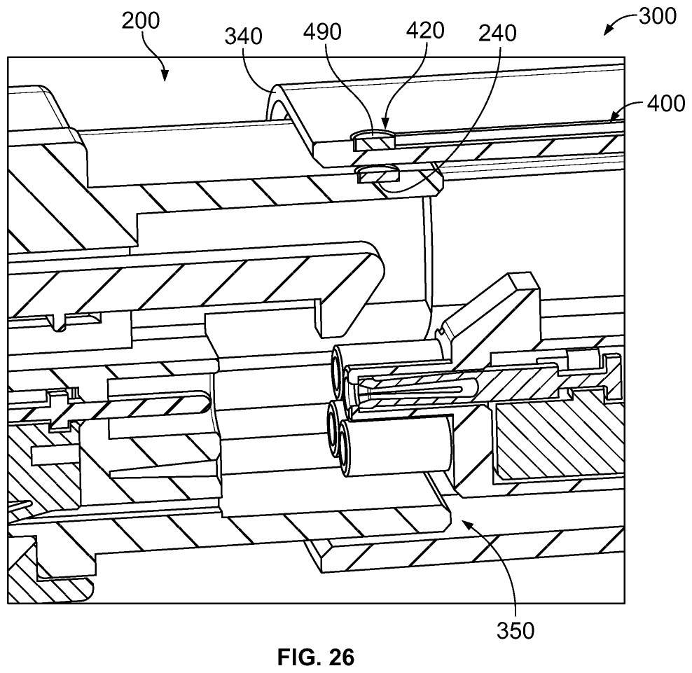

FIG. 25 is a front perspective view illustrating the receive charging device 300 in accordance with an exemplary embodiment. FIG. 26 is a cross sectional view of a portion of the receive charging device 300 in accordance with an exemplary embodiment. FIGS. 25 and 26 show the connector mating sensor assembly 400 in a different orientation. FIGS. 25 and 26 show the connector mating sensor assembly 400 having a different type of connector mating sensor 420. In the illustrated embodiment, the connector mating sensor 420 includes a proximity sensor 490. For example, the connector mating sensor 420 may be a hall effect sensor. The supply charging device 200 includes a sensor element 240 configured to be detected by the proximity sensor 490. The proximity sensor 490 is located proximate to the front 340 to determine when the supply housing 212 is removed from the receptacle 350.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

What is claimed is:

1. A receive charging device for a mobile device, the receive charging device comprising:
a receive power connector having a receive housing extending between a front and a rear, the receive power connector having a mating end at the front, the receive housing including a receptacle at the mating end configured to receive a supply power connector along a mating axis, the receive power connector having a cable end at the rear;
a contact assembly held by the receive housing, the contact assembly including receive power contacts for mating with supply power contacts of the supply power connector;
a cable assembly coupled to the contact assembly, the cable assembly including power cables terminated to the corresponding receive power contacts, the power cables extending from the cable end; and
a connector mating sensor assembly configured to be operably coupled to the supply power connector to indicate a mating status of the receive power connector with the supply power connector, the mating status being one of connected or disconnected.

2. The receive charging device of claim 1, wherein the connector mating sensor assembly determines the mating status of the receive housing with a supply housing of the supply power connector.

3. The receive charging device of claim 1, wherein the connector mating sensor assembly determines the mating status of the receive power connector relative to the supply power connector independent of a mating status of the receive power contacts relative to the supply power contacts.

4. The receive charging device of claim 1, wherein the connector mating sensor assembly monitors the mating status of the front of the receive housing.

5. The receive charging device of claim 1, wherein the connector mating sensor assembly includes a connector mating sensor having a switch element, the connector mating sensor assembly including an actuator operably coupled to the switch element, the actuator having an engagement tip located in the receptacle to interface with the supply power connector when the supply power connector is in the receptacle to activate the switch element indicating the connected mating status, the actuator being released when the supply power connector is removed from the receptacle to deactivate the switch element indicating the disconnected mating status.

6. The receive charging device of claim 5, wherein the actuator is pivotable between an actuated position and a released position, the actuator activating the switch element in the actuated position, the switch element deactivated when the actuator is in the released position.

7. The receive charging device of claim 6, wherein the connector mating sensor assembly includes a biasing element engaging the actuator and forcing the actuator toward the released position.

8. The receive charging device of claim 5, wherein the connector mating sensor assembly includes a carrier coupled to an exterior of the receive housing, the receive housing including a window therethrough, the actuator passing through the window to interface the engagement tip with the supply power connector.

9. The receive charging device of claim 5, wherein the connector mating sensor assembly includes a printed circuit board, the switch element mounted to the printed circuit board, the connector mating sensor assembly including an electrical connector mounted to the printed circuit board and electrically connected to the switch element through the printed circuit board.

10. The receive charging device of claim 1, wherein the connector mating sensor assembly includes a limit switch configured to be operably coupled to the supply power connector when the supply power connector is plugged into the receptacle.

11. The receive charging device of claim 1, wherein the connector mating sensor assembly includes a carrier holding a connector mating sensor, the carrier being coupled to an exterior of the receptacle housing, the connector mating sensor sensing when the supply power connector is located in the receptacle.

12. The receive charging device of claim 11, wherein the receive housing includes a window therethrough proximate to the front of the receive housing, the connector mating sensor sensing presence of the supply power connector through the window.

13. The receive charging device of claim 1, wherein the connector mating sensor assembly includes a proximity sensor configured to sense presence of the supply power connector in the receptacle.

14. The receive charging device of claim 1, wherein the connector mating sensor assembly includes a plunger and a biasing member forward biasing the plunger, the plunger being compressed by the supply power connector when the supply power connector is in the receptacle, the plunger being released from the supply power connector when the supply power connector is removed from the receptacle.

15. The receive charging device of claim 14, wherein the contact assembly includes signal contacts, the connector mating sensor assembly having a shorting contact coupled to and movable with the plunger, the shorting contact electrically shorting between the signal contacts when the plunger is released, the shorting contact being electrically isolated from the signal contacts when the plunger is compressed by the supply power connector.

16. The receive charging device of claim 1, further comprising a cover covering the connector mating sensor assembly.

17. A receive charging device for a mobile device, the receive charging device comprising:
a receive power connector having a receive housing extending between a front and a rear, the receive power connector having a mating end at the front, the receive housing including a receptacle at the mating end configured to receive a supply power connector along a mating axis, the receive power connector having a cable end at the rear;
a contact assembly held by the receive housing, the contact assembly including receive power contacts for mating with supply power contacts of the supply power connector;
a cable assembly coupled to the contact assembly, the cable assembly including power cables terminated to the corresponding receive power contacts, the power cables extending from the cable end; and
a connector mating sensor assembly configured to be operably coupled to the supply power connector to indicate a mating status of the receive power connector with the supply power connector, the mating status being one of connected or disconnected, the connector mating sensor assembly including a connector mating sensor having a switch element, the connector mating sensor assembly including an actuator operably coupled to the switch element, the actuator having an engagement tip located in the receptacle to interface with the supply power connector when the supply power connector is in the receptacle to activate the switch element indicating the connected mating status, the actuator being released when the supply power connector is removed from the receptacle to deactivate the switch element indicating the disconnected mating status.

18. The receive charging device of claim 17, wherein the actuator is pivotable between an actuated position and a released position, the actuator activating the switch element in the actuated position, the switch element deactivated when the actuator is in the released position.

19. The receive charging device of claim 18, wherein the connector mating sensor assembly includes a biasing element engaging the actuator and forcing the actuator toward the released position.

20. The receive charging device of claim 17, wherein the connector mating sensor assembly includes a carrier coupled to an exterior of the receive housing, the receive housing including a window therethrough, the actuator passing through the window to interface the engagement tip with the supply power connector.

21. The receive charging device of claim 17, wherein the connector mating sensor assembly includes a printed circuit board, the switch element mounted to the printed circuit board, the connector mating sensor assembly including an electrical connector mounted to the printed circuit board and electrically connected to the switch element through the printed circuit board.

22. The receive charging device of claim 17, wherein the connector mating sensor assembly determines the mating status of the receive housing with a supply housing of the supply power connector.

23. A charging system comprising:
a supply charging device including a supply power connector having a supply housing extending between a front and a rear, the supply housing having a top and a bottom, the supply power connector having a mating end at the front, the supply power connector having a cable end opposite the mating end, the supply power connector including supply power contacts held by the supply housing, the supply charging device including a supply cable assembly coupled to the supply power connector and extending from the cable end, the supply cable assembly including supply power cables terminated to the corresponding supply power contacts; and
a receive charging device for a mobile device, the receive charging device including a receive power connector having a receive housing extending between a front and a rear, the receive power connector having a mating end at the front configured to be mated with the mating end of the supply power connector, the receive housing including a receptacle at the mating end configured to receive a supply power connector along a mating axis, the receive power connector having a cable end at the rear, the receive charging device including a receive contact assembly held by the receive housing including receive power contacts for mating with the supply power contacts of the supply power connector, the receive charging device including a receive cable assembly coupled to the receive contact assembly and extending from the cable end, the receive cable assembly including receive power cables terminated to the corresponding receive power contacts, the receive charging device including a connector mating sensor assembly configured to be operably coupled to the supply power connector to indicate a mating status of the receive power connector with the supply power connector, the mating status being one of connected or disconnected.
